(19) United States
(12) Patent Application Publication
(10) Pub. No.: US 2025/0128683 A1
(43) Pub. Date: Apr. 24, 2025

(54) DRIVING ASSISTANCE DEVICE, DRIVING ASSISTANCE METHOD, AND NON-TRANSITORY COMPUTER-READABLE RECORDING MEDIUM WITH DRIVING ASSISTANCE PROGRAM RECORDED THEREON

(71) Applicant: Panasonic Automotive Systems Co., Ltd., Kanagawa (JP)

(72) Inventors: Toyoharu KURODA, Osaka (JP); Hirofumi NISHIMURA, Kanagawa (JP)

(73) Assignee: Panasonic Automotive Systems Co., Ltd., Kanagawa (JP)

(21) Appl. No.: 18/917,437

(22) Filed: Oct. 16, 2024

(30) Foreign Application Priority Data
Oct. 18, 2023 (JP) 2023-179788

(51) Int. Cl. B60T 7/22; B60Q 9/00

(52) U.S. Cl. CPC B60T 7/22; B60Q 9/008; B60T 2210/32

(57) ABSTRACT

A driving assistance device that performs driving assistance based on information on a distance between a vehicle and an obstacle, the driving assistance device including: a distance information generator that acquires the information on the distance detected by a sonar and generates sonar distance information in which the information on the distance corresponding a position of the vehicle is associated with information on the position of the vehicle, the position being one of positions of the vehicle; and a distance information storage that stores the sonar distance information.

### TECHNICAL FIELD

The present disclosure relates to a driving assistance device, a driving assistance method, and a non-transitory computer-readable recording medium with a driving assistance program recorded thereon.

### BACKGROUND ART

In the related art, a technique is known in which the orientation and the tilt of an alternative image corresponding to an obstacle detected by obstacle detection means are changed to match a virtual viewpoint, and the alternative image is superimposed on an overhead image. Disclosed in PTL 1 is a parking assistance device that uses digital image data of an image captured by an imaging device and vehicle movement data to calculate data specifying a three-dimensional object and a distance from the vehicle to the three-dimensional object, and converts the data into a bird's-eye view image from above.

### CITATION LIST

### Patent Literature

PTL 1
Japanese Patent Application Laid-Open No. 2001-187553

### SUMMARY OF INVENTION

### Technical Problem

In some cases, however, the control of a vehicle with high accuracy cannot be achieved by controlling a vehicle based on images captured by an imaging device.

The present disclosure is intended to solve the above-described problem, and an object thereof is to provide a driving assistance device, a driving assistance method, and a driving assistance program each capable of controlling a vehicle with high accuracy.

### Solution to Problem

In order to solve the above-described problem, one aspect of the driving assistance device according to the present disclosure is a driving assistance device that performs driving assistance based on information on a distance between a vehicle and an obstacle, the driving assistance device including: a distance information generator that acquires the information on the distance detected by a sonar and generates sonar distance information in which the information on the distance corresponding to a position of the vehicle is associated with information on the position of the vehicle, the position being one of positions of the vehicle; and a distance information storage that stores the sonar distance information.

One aspect of the driving assistance method according to the present disclosure is a driving assistance method that performs driving assistance based on information on a distance between a vehicle and an obstacle, the driving assistance method including: distance-information generating of acquiring the information on the distance detected by a sonar and generating sonar distance information in which the information on the distance corresponding to a position of the vehicle is associated with information on the position of the vehicle, the position being one of positions of the vehicle; and distance-information storing of storing the sonar distance information.

One aspect of a non-transitory computer-readable recording medium storing according to the present disclosure is a non-transitory computer-readable recording medium storing thereon a driving assistance program that performs driving assistance based on information on a distance between a vehicle and an obstacle, the driving assistance program causing a computer to execute processing, the processing comprising: distance-information generating of acquiring the information on the distance detected by a sonar and generating sonar distance information in which the information on the distance corresponding to a position of the vehicle is associated with information on the position of the vehicle, the position being one of positions of the vehicle; and distance-information storing of storing the sonar distance information.

### Advantageous Effects of Invention

According to the present disclosure, it is possible to control a vehicle with high accuracy.

### BRIEF DESCRIPTION OF DRAWINGS

FIG. 1 illustrates a state in which a vehicle in the present embodiment is in the process of parking in a parking space;

FIG. 2 illustrates the display of a fixture marker in a surround monitor in the present embodiment;

FIG. 3 is a configuration diagram illustrating a configuration of a driving assistance device in the present embodiment;

FIG. 4 is a flowchart of route information registration processing of the driving assistance device in the present embodiment;

FIG. 5 is a flowchart of the route reproduction processing in the driving assistance device in the present embodiment;

FIG. 6 illustrates automatic parking in the present embodiment;

FIG. 7 illustrates the positional relationship between a vehicle and a registered route in the present embodiment;

FIG. 8 illustrates automatic parking when an obstacle is present in the present embodiment; and

FIG. 9 illustrates automatic parking when an obstacle is present in the present embodiment.

### DESCRIPTION OF EMBODIMENTS

Hereinafter, embodiments of the present disclosure will be described with reference to the drawings. Embodiments described below are all specific examples of the present disclosure. Therefore, each component, the position of each component and the connection form, as well as each step and the order of the steps, and the like, shown in the following embodiments are examples and are not intended to limit the present disclosure. In addition, components in the following embodiments that are not described in the independent claims are described as optional components.

Each drawing is a schematic diagram and is not necessarily a strict illustration. In the drawings, the same symbol is attached to a substantially identical configuration, and redundant explanations are omitted or simplified.

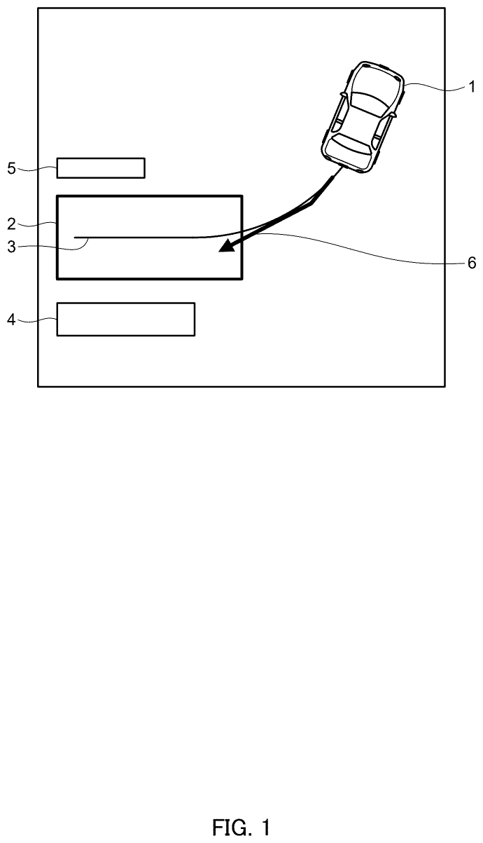

FIG. 1 illustrates a state in which vehicle 1 in the present embodiment is in the process of parking in parking space 2. When vehicle 1 automatically parks into parking space 2, vehicle 1 can park by utilizing route information 3 registered by manual parking in advance.

Further, in a case where there is an obstacle in the vicinity of vehicle 1 when manual parking or automatic parking is performed, box-shaped fixture markers 4 and 5 are displayed on a display such as a monitor. The shape of fixture markers 4 and 5 is not limited to a box shape, and may be another shape such as a wall shape.

The obstacle is a bicycle, a motorcycle, a flower bed, a fixture on land, or the like, and may be a person, an animal, or the like. The size of fixture markers 4 and 5 changes depending on the size of the obstacle. Fixture marker 4 indicates that it is a larger obstacle than fixture marker 5.

During automatic parking, vehicle 1 can complete parking safely without coming into contact with obstacles displayed as fixture markers 4 and 5 by backing up in the direction of arrow 6 by using route information 3.

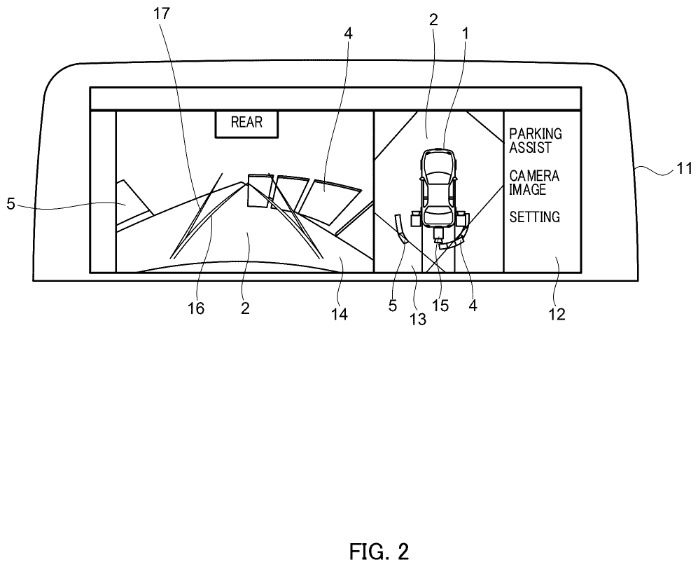

Further, an in-vehicle camera (FIG. 2) that is a peripheral sensor is mounted on vehicle 1 and monitors the peripheral environment of vehicle 1. In the present embodiment, the in-vehicle camera is applied to, for example, a purpose of detecting an obstacle in the periphery of vehicle 1 and estimating the presence position of vehicle 1 from a positional relationship between vehicle 1 and the obstacle in the periphery of vehicle 1.

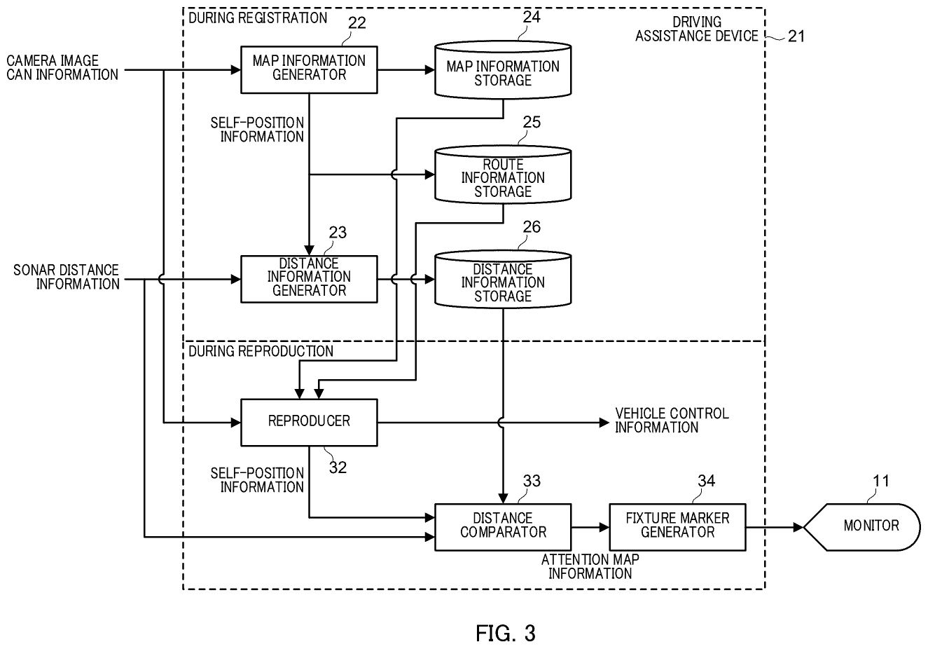

The in-vehicle camera is constituted by, for example, four cameras disposed so as to capture images in four directions, namely the forward direction, rearward direction, leftward direction, and rightward direction, of vehicle 1. The in-vehicle camera outputs a camera image generated by itself to driving assistance device 21 (FIG. 3).

Further, a sonar sensor is used to estimate the self-position of vehicle 1 more accurately, and the sonar sensor outputs sensor information obtained as a result of obstacle detection to driving assistance device 21.

Further, the in-vehicle sensor is various sensors that detect the traveling state of vehicle 1. The in-vehicle sensor includes, for example, an accelerator opening sensor that detects the accelerator opening, a steering angle sensor that detects the steering angle of a steering device, an acceleration sensor that detects an acceleration acting in the forward-rearward direction of vehicle 1, a torque sensor that detects a torque acting on a power transmission mechanism between the wheels of vehicle 1 and the engine or the drive motor, and a vehicle speed sensor that detects the vehicle speed of vehicle 1.

FIG. 2 illustrates the display of fixture markers 4 and 5 in surround monitor 11 in the present embodiment. Surround monitor 11 is a display installed at the front inside vehicle 1, and displays thereon setting screen 12, generated image 13, and camera image 14. Surround monitor 11 may be used for a car navigation device, a TV, or the like.

In the case of automatic parking or manual parking, the parking assist is displayed on setting screen 12. Further, in setting screen 12, it is possible to change the setting of the display image by touching the camera image or the setting.

Generated image 13 is an image illustrating a state in which vehicle 1 and fixture markers 4 and 5 are viewed from above. As illustrated in FIG. 2, by displaying fixture markers 4 and 5 only when the obstacles are close to vehicle 1, it is possible to call passenger's attention only when there is danger, without confusing the passenger.

Further, three cameras 15 on the left, right, and rear of vehicle 1 are displayed, and camera image 14 allows the passenger of vehicle 1 to confirm which area behind vehicle 1 is being photographed by camera 15. Further, by coloring fixture markers 4 and 5 with orange, green, or the like, the passenger of vehicle 1 can easily see that there is an obstacle.

Camera image 14 displays the rear of vehicle 1 photographed by camera 15. For example, a plurality of orange fixture markers 4 are displayed behind the right side of vehicle 1, and green fixture marker 5 is displayed behind the left side of vehicle 1.

Further, by displaying orange line 16 up to fixture marker 4, the passenger can easily grasp the distance to fixture marker 4. Further, by displaying green line 17, the passenger can confirm that vehicle 1 will not collide with fixture marker 5 even when proceeding rearward, but will collide with fixture marker 4.

FIG. 3 is a configuration diagram illustrating a configuration of driving assistance device 21 in the present embodiment. Driving assistance device 21 includes map information generator 22, distance information generator 23, map information storage 24, route information storage 25, distance information storage 26, reproducer 32, distance comparator 33, and fixture marker generator 34.

At the time of registering the parking route, map information generator 22 performs self-position estimation based on the camera image and the CAN information, and generates feature point map information in which feature points of a obstacle in the vicinity of vehicle 1 are registered.

Further, map information generator 22 stores the generated feature point map information in map information storage 24, and stores, in route information storage 25, route information on vehicle 1 obtained as a result of the self-position estimation.

This processing is performed using a simultaneous localization and mapping (SLAM) technology that performs self-position estimation of vehicle 1 and environmental map generation simultaneously.

Vehicle 1 equipped with SLAM estimates the amount of movement from the rotation amount of the wheels and an image sensor such as a sonar sensor or a camera, and at the same time generates feature point map information, which is map information on an obstacle in the vicinity of vehicle 1, by using a sensor such as a camera.

Based on the information on distance from vehicle 1 to an obstacle in the vicinity of vehicle 1 (which is obtained from a sonar sensor, distance information generator 23 generates distance information by associating the obtained information with information on the self-position of the vehicle. Subsequently, distance information generator 23 stores the generated distance information in distance information storage 26. Map information storage 24, route information storage 25, and distance information storage 26 are not limited to being configured separately, but may form one storage.

During reproducing a parking route, reproducer 32 performs self-position estimation based on the camera image, the CAN information, the feature point map information, and the route information, generates vehicle control information for controlling vehicle 1 to travel the route registered as the route information, and outputs the vehicle control information to a device such as an electronic control unit (ECU) for controlling the travel of vehicle 1.

Distance comparator 33 compares the information on the distance from vehicle 1 to an obstacle in the periphery of vehicle 1 (which is acquired by the sonar sensor) with sonar distance information stored in distance information storage 26 at the time of the registration of the route information, and generates attention map information including information on the position and the size of the obstacle for which attention should be paid.

Fixture marker generator 34 generates information on a fixture marker that indicates a fixture located close to vehicle 1, from the attention map information. Based on this information, monitor 11 displays fixture markers 4 and 5 as illustrated in FIG. 2.

Herein, a case where the fixture marker is displayed for a fixture in the vicinity of a vehicle will be described. When a parking route is reproduced, there is a possibility that an obstacle (which was not present during the registration of the parking route) is present is detected, but such an obstacle (which was not present during the registration) can be distinguished from a fixture that has been fixed to land by using a method such as projection difference.

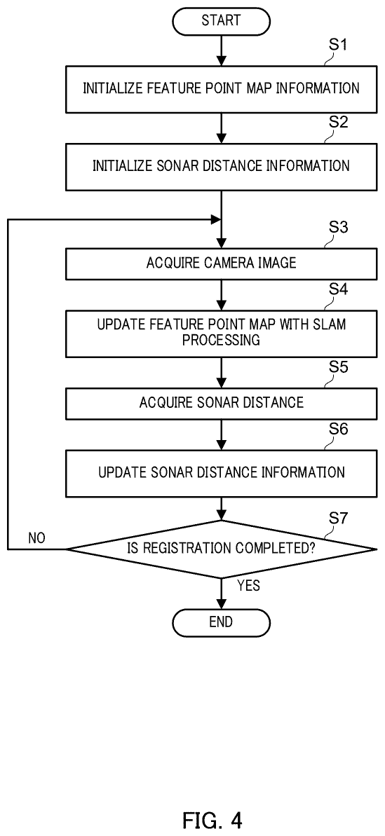

FIG. 4 is a flowchart of route information registration processing of driving assistance device 21 in the present embodiment. Map information generator 22 of driving assistance device 21 initializes the feature point map information (step S1). Further, distance information generator 23 initializes the sonar distance information (step S2).

Then, map information generator 22 acquires camera image 14 and CAN information (step S3), and updates the feature point map information with simultaneous localization and mapping (SLAM) processing (step S4).

Subsequently, distance information generator 23 acquires the information on the distance from the sonar sensor (step S5), and updates the sonar distance information (step S6).

When the registration of the parking route information is not completed (step S7, NO), map information generator 22 and distance information generator 23 repeat the processing from step S3, and when the registration of the parking route information is completed (step S7, YES), this route information registration processing ends.

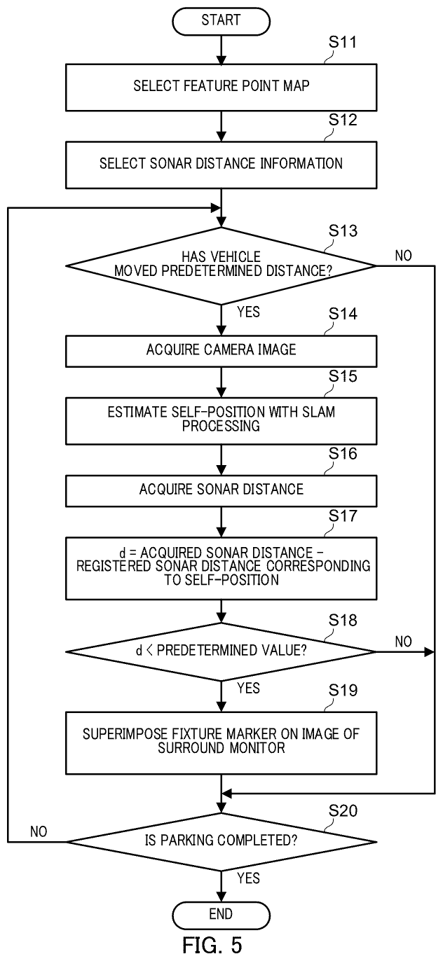

FIG. 5 is a flowchart of the route reproduction processing in driving assistance device 21 in the present embodiment. Reproducer 32 of driving assistance device 21 selects feature point map information corresponding to the current self-position of vehicle 1 (step S11), and further selects sonar distance information (step S12).

Then, reproducer 32 determines whether vehicle 1 has moved a predetermined distance (step S13), and when vehicle 1 has moved the predetermined distance (step S13, YES), acquires camera image 14 (step S14), and estimates the self-position with SLAM processing (step S15).

Subsequently, distance comparator 33 acquires the information on the distance from the sonar sensor and acquires sonar distance information corresponding to the self-position of vehicle 1 registered in distance information storage 26 (step S16), and calculates difference d between them by the following calculation formula (step S17).

d=(sonar distance acquired from sonar sensor)−(registered sonar distance corresponding to self-position)

Then, when difference d is smaller than a predetermined value (step S18, YES), vehicle 1 is close to an obstacle, and therefore, fixture marker generator 34 superimposes the fixture marker on the image of surround monitor 11 (step S19). Here, the above-described predetermined value is a negative value, and can be appropriately set according to the tolerance of the distance at which vehicle 1 approaches an obstacle.

When vehicle 1 has not moved the predetermined distance in step S13 (step S13, NO), when the processing in step S19 is completed, or when difference d is equal to or larger than the predetermined value (step S18, NO), reproducer 32 determines whether parking is completed (step S20). When parking is completed (step S20, YES), the route reproduction processing ends.

When parking is not completed (step S20, NO), the processing from step S13 is continued.

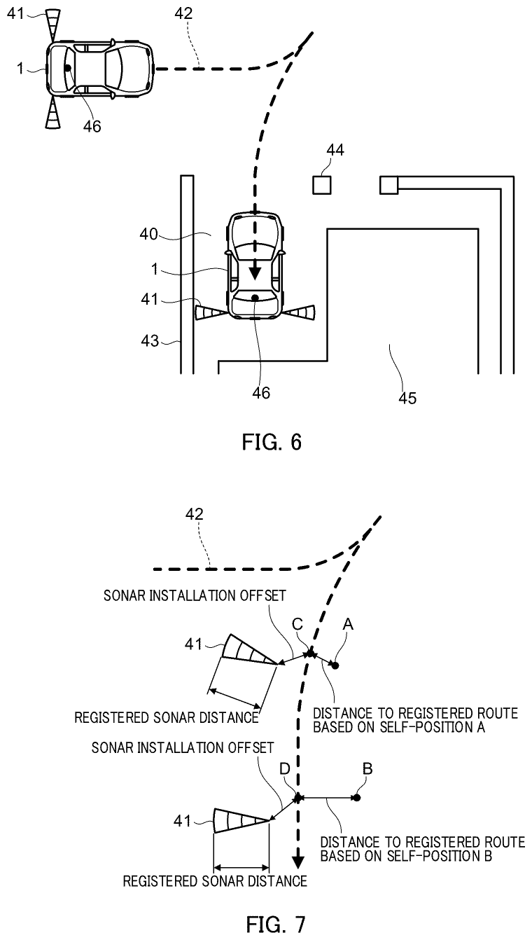

FIG. 6 illustrates automatic parking in the present embodiment. For example, vehicle 1 stops on a public road for automatic parking into parking space 40 at home. Sonar distance 41 is virtually displayed at the rear of vehicle 1. Wall 43, gate 44, and home 45 are in the periphery of parking space 40. Vehicle 1 passes through registered route 42 of the broken line, and is parked in parking space 40.

In the automatic parking in the present embodiment, three modes are set. The automatic parking is not limited to the three modes, and another mode may be set.

First, mode 1 will be described. Mode 1 is a case in which, as illustrated in FIG. 6, there is no change in an obstacle as compared to the time of registering the route information, and automatic parking is performed following registered route 42.

In the case of mode 1, distance comparator 33 calculates difference d in step S17 in FIG. 5 using the following calculation formula described above.

d=(sonar distance acquired from sonar sensor)−(registered sonar distance corresponding to self-position)

Here, when distance comparator 33 selects the registered sonar distance corresponding to the self-position, distance comparator 33 searches for a position closest to the current self-position, using the position of vehicle 1 at the time of route information registration as a search target, and selects the registered sonar distance corresponding to that position.

The sampling interval of the route information to be registered is arbitrary according to the system performance. In addition, origin 46 of vehicle 1 is, for example, the rear wheel axle center.

When difference d is smaller than the predetermined value described above, it is recognized that vehicle 1 is close to an obstacle, and the fixture marker is displayed on monitor 11.

FIG. 7 illustrates the positional relationship between vehicle 1 and registered route 42 in the present embodiment. When vehicle 1 deviates from registered route 42 to be located at self-position A, the registered vehicle position that is closest to self-position A is C. Thus, position C is searched as the position (closest to current self-position A) of vehicle 1 at the time of the registration of the route information, and difference d described above is calculated.

Further, when vehicle 1 deviates from registered route 42 and to be located at self-position B, the registered vehicle position that is closest to self-position B is D. Thus, position D is searched as the position (closest to current self-position B) of vehicle 1 at the time of the registration of the route information, and above-described difference d is calculated. The sonar installation offset in FIG. 7 indicates a relative installation position from vehicle origin 46 of the sonar sensor.

Further, in mode 1, a case is also conceivable in which there is an obstacle (which was not present during the registration of the parking route) is present when the parking route is reproduced and is detected, but such an obstacle (which was not present during the registration) can be distinguished from a fixture that has been fixed to land by a method such as projection difference.

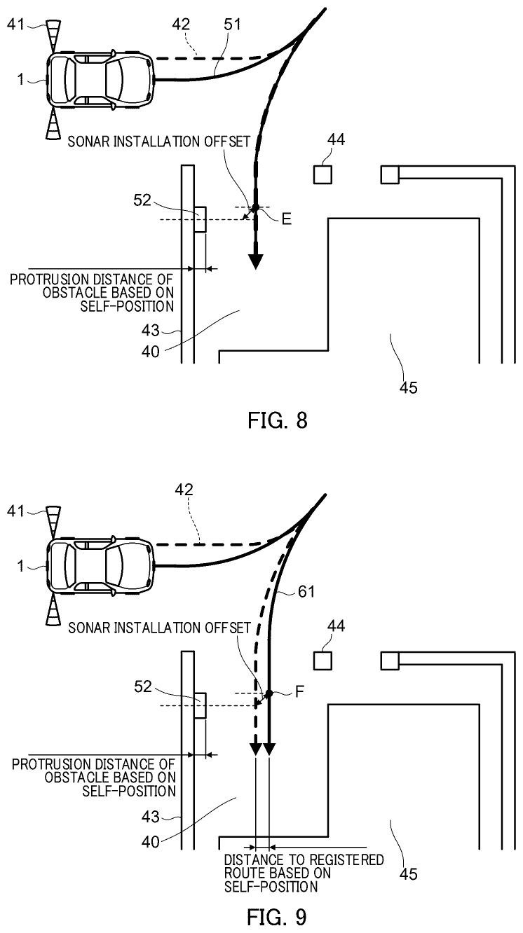

Next, mode 2 will be described. FIG. 8 illustrates automatic parking when obstacle 52 is present in the present embodiment. Mode 2 is a case where obstacle 52 (which was not present during the registration of the parking route) is detected when the parking route is reproduced, but the vehicle is automatically parked along route 51, namely, a solid line following registered route 42. Obstacle 52 is a bicycle of a visitor, a flowerpot protruding from home 45 to parking space 40, or the like.

In the case, the calculation formula of difference d in mode 1 in step S17 in FIG. 5 is replaced with the following calculation formula.

d=(acquired sonar distance)−(registered sonar distance corresponding to self-position)+(protrusion distance of obstacle corresponding to self-position)

In this calculation formula, the acquired sonar distance and the registered sonar distance corresponding to the self-position are the same as those in mode 1. The protrusion distance of obstacle corresponding to the self-position is, for example, the protrusion distance of obstacle 52 from wall 43 toward the route 51 side.

When difference d is smaller than the predetermined value described above, it is recognized that vehicle 1 is close to obstacle 52, and the fixture marker is displayed on monitor 11.

Next, mode 3 will be described. FIG. 9 illustrates automatic parking when obstacle 52 is present in the present embodiment. Mode 3 is a case where obstacle 52 (which was not present during the registration of the parking route) is detected when the parking route is reproduced, and in order to avoid obstacle 52, the vehicle is automatically parked by following solid-line bypass route 61 obtained by correcting registered route 42.

In the case, the calculation formula of difference d in mode 1 in step S17 in FIG. 5 is replaced with the following calculation formula.

d=(acquired sonar distance)−(registered sonar distance corresponding to self-position)+(protrusion distance of obstacle corresponding to self-position)+(distance between registered route corresponding to self-position and bypass route)

In this calculation formula, the acquired sonar distance, the registered sonar distance corresponding to the self-position, and the protrusion distance of obstacle corresponding to the self-position are the same as those in mode 1 and mode 2.

When difference d is smaller than the predetermined value, it is recognized that vehicle 1 is close to obstacle 52, and the fixture marker is displayed on monitor 11.

In all cases of mode 1, mode 2, and mode 3, the passenger of vehicle 1 can pay attention to whether vehicle 1 collides with an obstacle or not by displaying the fixture marker on monitor 11.

Further, at the time of registration of route information and at the time of reproduction of route information, when vehicle 1 is close to an obstacle and a fixture marker is displayed, driving assistance device 21 outputs a warning sound from the sound output, but the type of the warning sound to be output from the sound output may be changed between when the route information is registered and when the route information is reproduced. For example, during the registration of the route information, manual driving is performed and more attention is required, and thus, the sound output may output a warning sound that is more urgent when the route information is registered than when the route information is reproduced.

Further, when the route information is reproduced, the sound output may change the type of the warning sound to be output according to a degree to which vehicle 1 is deviated from the route registered at the time of registration of the route information. For example, the sound output may output a warning sound that is more urgent as vehicle 1 deviates from the route registered at the time of registration.

Further, a collision avoidance device such as autonomous emergency braking (AEB) that vehicle 1 has operates the brake automatically when vehicle 1 detects an obstacle, and slows down the speed of vehicle 1 or stops vehicle 1, but the control criterion of vehicle 1 may be changed between when the route information is registered and when the route information is reproduced.

For example, when route information is registered, manual driving is performed and more attention is necessary, and thus, the collision avoidance device may increase the distance between vehicle 1 operating the brake and an obstacle during the registration of the route information as compared to the distance between vehicle 1 operating the brake and an obstacle during the reproduction of the route information.

Further, when vehicle 1 deviates from the route registered at the time of registration, fixture marker generator 34 may display the fixture marker located in the direction in which vehicle 1 deviates more emphatically than the fixture marker located on the side opposite to the direction in which vehicle 1 deviates. The emphasis includes not only displaying the fixture marker in a more noticeable manner, but also not displaying the fixture marker on the opposite side.

Although the embodiments have been described above, the present disclosure is not limited to the above-described embodiments.

For example, in the above-described embodiments, each component may be realized by executing a software program suitable for each component. Each component may be realized by a program execution unit such as a CPU or a processor reading and executing a software program recorded on a recording medium such as a hard disk or a semiconductor memory.

Furthermore, the general or specific aspects of the present invention may be implemented as an apparatus, a method, an integrated circuit, a computer program, or a computer-readable recording medium such as a CD-ROM, or any selective combination thereof.

In addition, the present disclosure also includes forms obtained by applying various modifications to each embodiment that a person skilled in the art may conceive, or forms realized by arbitrarily combining the components and functions of each embodiment within the scope that does not deviate from the spirit of the present disclosure.

The disclosure of Japanese Patent Application No. 2023-179788 filed on Oct. 18, 2023 including the specification, drawings and abstract is incorporated herein by reference in its entirety.

### INDUSTRIAL APPLICABILITY

The present disclosure can be utilized for a driving assistance device, a driving assistance method, and a driving assistance program.

### REFERENCE SIGNS LIST

1 Vehicle
2 Parking space
3 Registered route information
4 Fixture marker
11 Monitor
12 Setting screen
13 Generated image
14 Camera image
15 Camera
21 Driving assistance device
22 Map information generator
23 Distance information generator
24 Map information storage
25 Route information storage
26 Distance information storage
32 Reproducer
33 Distance comparator
34 Fixture marker generator
40 Parking space
41 Registered sonar distance
42 Registered route
46 Vehicle origin
52 Obstacle
61 Bypass route

1. A driving assistance device that performs driving assistance based on information on a distance between a vehicle and an obstacle, the driving assistance device comprising:
a distance information generator that acquires the information on the distance detected by a sonar and generates sonar distance information in which the information on the distance corresponding to a position of the vehicle is associated with information on the position of the vehicle, the position being one of positions of the vehicle; and
a distance information storage that stores the sonar distance information.

2. The driving assistance device according to claim 1, further comprising:
a marker generator that, during execution of the driving assistance, generates information on a marker based on a comparison between the sonar distance information and the information on the distance detected by the sonar, wherein the marker indicates the obstacle and is to be displayed on a display.

3. The driving assistance device according to claim 2, wherein
the marker generator generates the information on the marker when the distance detected by the sonar is smaller than a distance registered in the sonar distance information.

4. The driving assistance device according to claim 2, further comprising:
a sound output that outputs, during manual driving in which the information on the distance detected by the sonar is acquired, a warning sound when the marker is displayed on the display,
wherein the sound output outputs, during the manual driving, the warning sound different from a warning sound that is output during the execution of the driving assistance.

5. The driving assistance device according to claim 2, further comprising:
a sound output that outputs a warning sound when the marker is displayed on the display,
wherein, when the vehicle deviates from a route registered by manual driving, the sound output outputs warning sounds of different types depending on a degree of deviation from the route.

6. The driving assistance device according to claim 1, further comprising:
a collision avoidance device that operates a brake of the vehicle when the obstacle is detected,
wherein the collision avoidance device increases a distance between the vehicle operating the brake and an obstacle during manual driving as compared to a distance between the vehicle operating the brake and an obstacle during the execution of the driving assistance, the manual driving being driving in which the information on the distance detected by the sonar is acquired.

7. The driving assistance device according to claim 2, wherein
when the vehicle deviates from a route registered by manual driving, the marker generator displays the marker located in a direction in which the vehicle deviates more emphatically than the marker located on a side opposite to the direction in which the vehicle deviates.

8. The driving assistance device according to claim 2, wherein
the marker generator generates the information on the marker when the obstacle having not been present during manual driving is present during the execution of the driving assistance, the manual driving being driving in which the information on the distance detected by the sonar is acquired, and when the distance detected by the sonar is smaller than a distance obtained by subtracting, from a distance registered in the sonar distance information, a distance over which the obstacle protrudes.

9. The driving assistance device according to claim 2, wherein
the marker generator generates the information on the marker when the obstacle having not been present during manual driving is present during the execution of the driving assistance, the manual driving being driving in which the information on the distance detected by the sonar is acquired, when the vehicle travels a bypass route for avoiding the obstacle, the bypass route being not a route registered by the manual driving, and when the distance detected by the sonar is smaller than a distance obtained by subtracting a distance over which the obstacle protrudes and a distance between the route registered by the manual driving and the bypass route from a distance registered in the sonar distance information.

10. A driving assistance method that performs driving assistance based on information on a distance between a vehicle and an obstacle, the driving assistance method comprising:
distance-information generating of acquiring the information on the distance detected by a sonar and generating sonar distance information in which the information on the distance corresponding to a position of the vehicle is associated with information on the position of the vehicle, the position being one of positions of the vehicle; and
distance-information storing of storing the sonar distance information.

11. The driving assistance method according to claim 10, further comprising:
marker generating of, during execution of the driving assistance, generating information on a marker based on a comparison between the sonar distance information and the information on the distance detected by the sonar, wherein the marker indicates the obstacle and is to be displayed on a display.

12. The driving assistance method according to claim 11, wherein
in the marker generating, the information on the marker is generated when the distance detected by the sonar is smaller than a distance registered in the sonar distance information.

13. The driving assistance method according to claim 11, further comprising:
sound outputting of outputting, during manual driving in which the information on the distance detected by the sonar is acquired, a warning sound when the marker is displayed on the display,
wherein, in the sound outputting, the warning sound different from a warning sound that is output during the execution of the driving assistance is output during the manual driving.

14. The driving assistance method according to claim 11, further comprising:
sound outputting of outputting a warning sound when the marker is displayed on the display,
wherein, in the sound outputting, when the vehicle deviates from a route registered by manual driving, warning sounds of different types are output depending on a degree of deviation from the route.

15. The driving assistance method according to claim 10, further comprising:
collision avoiding of operating a brake of the vehicle when the obstacle is detected,
wherein, in the collision avoiding, a distance between the vehicle operating the brake and an obstacle during manual driving is increased as compared to a distance between the vehicle operating the brake and an obstacle during the execution of the driving assistance, the manual driving being driving in which the information on the distance detected by the sonar is acquired.

16. The driving assistance method according to claim 11, wherein
in the marker generating, when the vehicle deviates from a route registered by manual driving, the marker located in a direction in which the vehicle deviates is displayed more emphatically than the marker located on a side opposite to the direction in which the vehicle deviates.

17. The driving assistance method according to claim 11, wherein
in the marker generating, the information on the marker is generated when the obstacle having not been present during manual driving is present during the execution of the driving assistance, the manual driving being driving in which the information on the distance detected by the sonar is acquired, and when the distance detected by the sonar is smaller than a distance obtained by subtracting, from a distance registered in the sonar distance information, a distance over which the obstacle protrudes.

18. The driving assistance method according to claim 11, wherein
in the marker generating, the information on the marker is generated when the obstacle having not been present during manual driving is present during the execution of the driving assistance, the manual driving being driving in which the information on the distance detected by the sonar is acquired, when the vehicle travels a bypass route for avoiding the obstacle, the bypass route being not a route registered by the manual driving, and when the distance detected by the sonar is smaller than a distance obtained by subtracting a distance over which the obstacle protrudes and a distance between the route registered by the manual driving and the bypass route from a distance registered in the sonar distance information.

19. A non-transitory computer-readable recording medium storing thereon a driving assistance program that performs driving assistance based on information on a distance between a vehicle and an obstacle, the driving assistance program causing a computer to execute processing, the processing comprising:
distance-information generating of acquiring the information on the distance detected by a sonar and generating sonar distance information in which the information on the distance corresponding to a position of the vehicle is associated with information on the position of the vehicle, the position being one of positions of the vehicle; and
distance-information storing of storing the sonar distance information.
